(19) United States
(12) Patent Application Publication
(10) Pub. No.: US 2003/0024163 A1
(43) Pub. Date: Feb. 6, 2003

(54) Method of packaging edible plants

(76) Inventor: David G. Sasuga, Vista, CA (US)

Correspondence Address: Joan H. Pauly, BARNARD & PAULY, P.S., P.O. Box 58888, Seattle, WA, 98138-1888, US

(21) Appl. No.: 09/919,469

(22) Filed: Jul. 31, 2001

(51) Int. Cl. A01G 9/02

(52) U.S. Cl. 47/84

(57) ABSTRACT

Plants are grown on a growing medium to a seedling stage in which the stems of the plants remain soft and edible. The growing medium is placed in a shallow tray or the shallow bottom of a container. The stems of the plants project upwardly from the growing medium above the tray or into the top portion of the closed container. The tray or container is distributed to consumers while the plants are still in the seedling stage so that both the stems and leaves of the plants are consumable. The shallow tray or bottom portion of the container allows easy snipping of the plant stems for consumption of some of the plants and keeping the rest of the plants in the tray or container for later use.

### TECHNICAL FIELD

This invention relates to a method of packaging edible seedlings for distribution to and use by consumers and, more particularly, to a method in which plants are grown on a growing medium to a seedling stage in which the stems of the plants remain soft and edible. The growing medium is placed in a shallow tray or the shallow bottom of a container and distributed for sale to consumers. A top surface of the medium is closely adjacent to the top edge of the tray or container bottom portion to allow easy snipping of the plant stems without removing the medium from the tray or bottom portion.

### BACKGROUND INFORMATION

Fresh herbs are commonly marketed in flat shallow containers with the container label being placed on one of the faces of the container. A usual method of placing the containers on display in a retail store is to provide a special rack or hanger on which the packages are hung or held in a vertical position so that the labels are easily visible to customers. Absent a special rack or hanger, the packages are often arranged in a leaning position to display them with the labels substantially facing customers. Thus, the use of the shallow containers results in display procedures that are awkward and/or require specialized fixtures.

At present, fresh herbs are marketed when they have already reached a stage of development in which the stems are relatively mature and tough. This renders the stems inedible so that a consumer of the herbs must trim the still edible leaves off the tough stems in order to prepare for consumption of the herb.

### BRIEF SUMMARY OF THE INVENTION

The invention provides a method of packaging edible seedlings for distribution to and use by consumers. According to a first embodiment of the invention, the method comprises providing a tray that includes a bottom surface and an upper edge surface. The tray has a predetermined height dimension that extends from the bottom surface to the upper edge surface. Plants are grown on a growing medium to a seedling stage. The medium is placed in the tray. The tray, with the medium placed in the tray and the plants growing on the medium, is distributed for sale to a consumer while the plants are still in the seedling stage. The height dimension of the tray is such that a top surface of the growing medium is closely adjacent to the upper edge surface of the tray when the medium is placed in the tray.

According to a second embodiment of the invention, the method comprises providing a container that includes a top portion and a bottom portion. The container has a closed position in which the top portion and the bottom portion meet at an interface. Plants are grown on a growing medium to a seedling stage. The medium is placed in the bottom portion of the container. With the medium in the bottom portion, the container is closed into its closed position. The closed container is distributed for sale to a consumer while the plants are still in the seedling stage. The bottom portion of the container has a height dimension such that a top surface of the growing medium is closely adjacent to the interface between the top and bottom portions when the medium is placed in the bottom portion. The top portion has a height dimension such that, when the container is in its closed position and the medium is in the bottom portion with the plants in the seedling stage extending upwardly therefrom, the plants are freely received in and protected by the top portion.

As used herein, when the plants are grown from seed, the term “seedling stage” refers to a stage of development of the plants which follows and does not include the sprout stage and in which both the stems and leaves of the plants remain soft and edible. At this seedling stage, the first set of true leaves of the plants, referred to as secondary leaves, have emerged and fully expanded. When the plants are grown from cuttings, the term refers to a stage of development of new shoot growth in which both the stems and leaves of the plants remain soft and edible. In contrast, the terms “sprout” or “microgreen” are food industry terms for a recently germinated seed, approximately three to ten days old. The germinated seed is characterized by having only the initial root, called the radicle, the stem, and the primary leaves, called the cotyledon. Sprouts and microgreens are consumed prior to the emergence or full expansion of the first set of true leaves.

The medium may be placed in the tray or the bottom portion of the container before or after the plants are grown on the medium to the seedling stage. However, when the plants are to be distributed in a container with a top portion, it is generally preferable to place the medium in the bottom portion after the plants have been grown to the seedling stage.

The construction of the container that is provided as part of the second embodiment of the invention and is used in the practice of that embodiment may be varied. In the currently preferred embodiment, the top portion and the bottom portion of the container are hingedly connected to each other along a side portion of the interface. The preferred embodiment also includes a latch to releasably secure the container in the closed position. When the container is provided with a latch, the closing of the container preferably includes engaging the latch. Containers that have both the hinge feature and the latch feature preferably have the latch positioned opposite the side portion of the interface where the hinge is located.

Another preferred feature relating to the container is providing the container with venting to allow the plants to have access to fresh air when the plants are in the container and the container is in its closed position. The venting may be provided in various ways. A basic way of providing the venting is simply to provide openings in the walls of the top portion and/or bottom portion of the container. Another example of a venting arrangement is one in which one or more gaps are left between the top portion and the bottom portion when the container is in its closed position. This venting arrangement is particularly expedient in a container that also has a hinge and a latch.

The container is preferably structured to facilitate its display to customers and to maximize the ease of use of customers. To facilitate display, the method preferably comprises providing a plurality of the containers, and providing the top portion and the bottom portion of each container with complementary portions to facilitate stacking of the containers and inhibit accidental tipping of a stack of the containers. This arrangement makes it easy to set up a display in a retail establishment and makes the containers easily accessible to customers.

Once a consumer has purchased the container/plants, the ease of consumption of the plants can be maximized. Preferably, the container has an open position in which, when the medium is in the bottom portion with the plants in the seedling stage extending upwardly from the medium, the plants are easily accessible to a user to allow stem portions of the plants to be snipped. When the container is provided with a hinge, all the consumer need do is pivot the top portion into an open position, snip the stems to remove the desired number of plants, and reclose the container.

It is currently anticipated that the method of the invention will be used at least primarily for packaging culinary herbs. However, other types of edible plants with a similar seedling stage may also be packaged and distributed in accordance with the method of the invention.

The invention provides a number of advantages to producers of edible plants, wholesale and retail sellers of the plants, and the ultimate consumers of the plants. The benefits to the producers include a cost efficient method of producing and distributing the plants and a high quality product with superior potential for marketing success. The benefits to intermediaries between the producers and retailers include packaging that is easily handled and transported and a product that does not require refrigeration. Retailers also benefit from the easy handling of the packaging and lack of a need for refrigeration. The preferred feature of complementary portions of the container to facilitate stacking increases the ease and efficiency of display of the product to customers and efficient handling of the retailers stock. The ultimate consumers benefit from the potential for easily perceived displays of the product in retail establishments and a high quality fresh product. Once a consumer has purchased a container of the plants, the plants can be readily consumed as needed over a period of time.

These and other features and advantages will become apparent from the detailed description of the invention that follows.

### BRIEF DESCRIPTION OF THE DRAWINGS

In the drawings, like element designations refer to like parts throughout, and:

FIG. 1 is a pictorial view of a tray with growing medium having plants growing thereon positioned therein, with portions of the tray cut away.

FIG. 2 is a pictorial view of the preferred embodiment of the container in an open position showing the growing medium and plants positioned therein.

FIG. 3 is like FIG. 2 except that it shows the container in a closed position.

FIG. 4 is a vertical sectional view of a plurality of the containers in a stacked position.

FIG. 5 is like FIG. 3 except that it illustrates the stems of individual plants being snipped to prepare the plants for consumption.

FIG. 6 is a simplified elevational view of another embodiment of the container illustrating the venting and latch features of the invention.

### DETAILED DESCRIPTION OF THE INVENTION

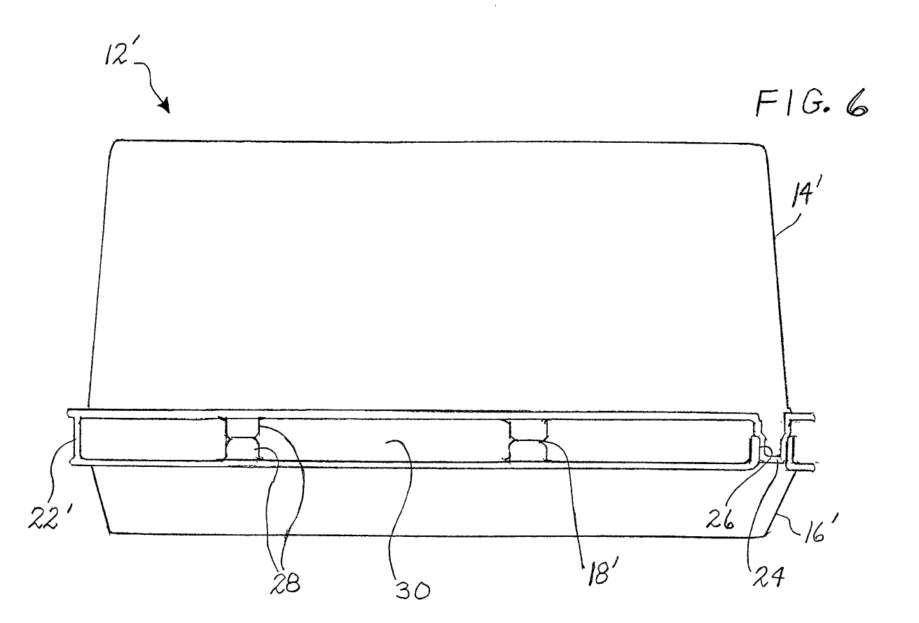

The drawings illustrate a tray 10 and a container 12, 12′ and their manner of use in the preferred embodiments of practicing the method of the invention. FIGS. 2-5 illustrate a container 12 that embodies the configuration that is currently preferred for the practice of the second embodiment of the invention. However, it is intended to be understood that the details of the construction of the container may be varied considerably without departing from the spirit and scope of the invention. The container 12′ shown in FIG. 6 is another example of a container that may be used in the practice of the invention.

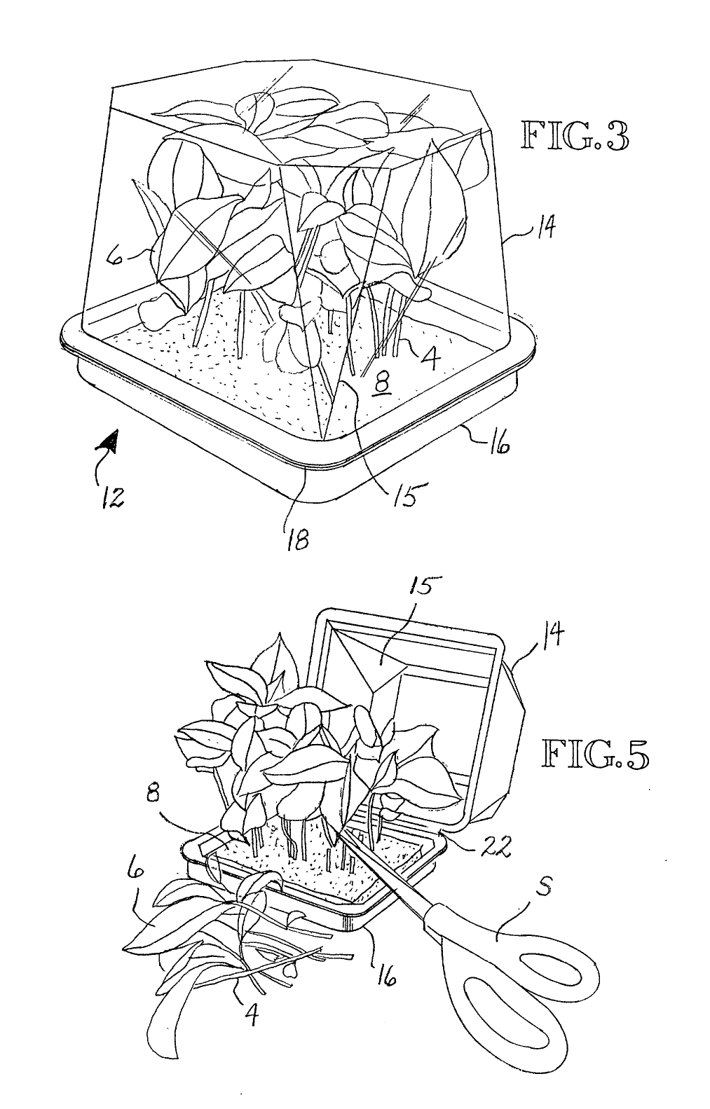

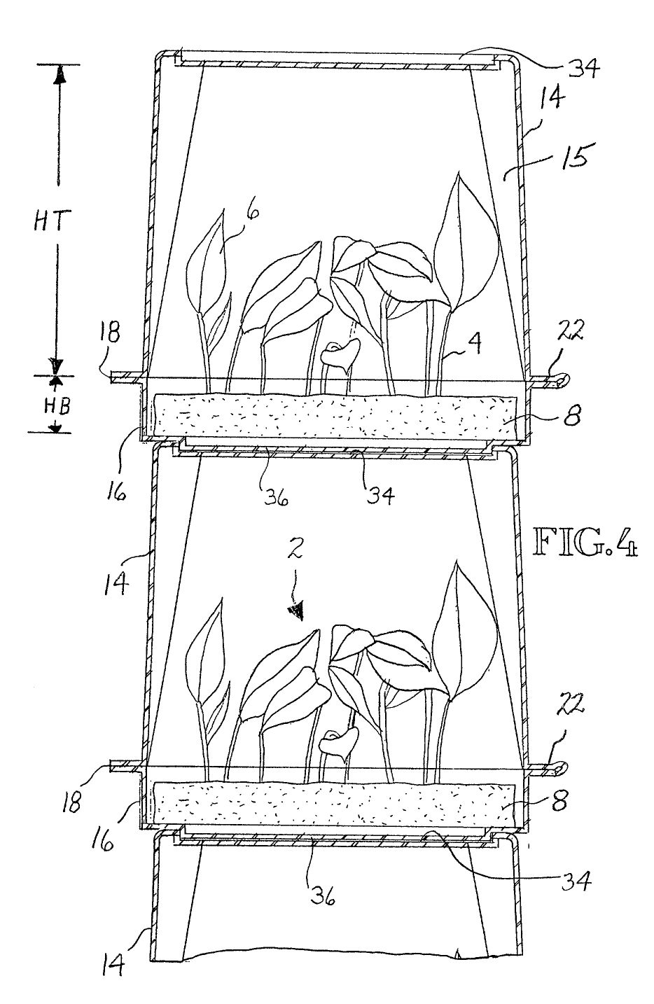

Referring to FIGS. 2-5, the container 12 includes a top portion 14 and a bottom portion 16. The container 12 has a closed position, illustrated in FIGS. 3 and 4, in which the top portion 14 and the bottom portion 16 meet at an interface 18. The term “meet at an interface” includes contact all around the interface, as shown in FIGS. 3 and 4, contact at spaced portions of the interface, as shown in FIG. 6, and continuous or partial overlapping contact. In the practice of the second embodiment of the invention, it is preferable to use a container that has top and bottom portions that are hingedly connected to each other along a side portion of the interface between the top and bottom portions. The hinge 22 of the container 12 is best seen in FIGS. 2, 4, and 5. The hinge 22 is simply formed by a continuous web of material between the top and bottom portions 14, 16. This type of hinge structure and the type of molded plastic from which the container 12 is made are well known.

FIG. 4 illustrates a feature of the container 12 that facilitates the stacking of a plurality of the containers 12. This feature is complementary portions of the top and bottom portions 14, 16 of the container 12 that interengage to facilitate stacking of the containers 12 and inhibit accidental tipping of a stack of the containers 12. Referring to FIG. 4, the upper or top wall of the top portion 14 of the container 12 has a shallow recess 34 formed therein. The recess 34 preferably has a substantially square configuration. The bottom wall of the bottom portion 16 of the container 12 has a complementary projection 36 formed thereon. The projection 36 preferably has the same configuration as the recess 34 with slightly reduced width and length dimensions so that the projection 36 easily fits into, and is removed from, the recess 34. This arrangement substantially prevents lateral movement of the projection 36 in the recess 34 and thereby inhibits lateral movement of the stacked containers 12 relative to each other.

The plan configuration of the container may be substantially rectangular, as shown in FIGS. 2, 3, and 5, square, round, or some other shape. Preferably, the dimensions of the container are such that a side of the container is large enough to accommodate a label that is easily readable from the side of a stack of containers. Also preferably, the dimensions are such that a plurality of containers forms a stable stack resistant to tipping even without the preferred feature of complementary projections and recesses.

The container 12 is preferably formed of clear thin-walled but substantially rigid plastic to minimize cost and weight but provide protection for the contents of the container. As shown in FIGS. 2-5, the top portion 14 of the container 12 has triangular corner facets 15 formed thereon. These facets 15 are included for aesthetic reasons and do not affect the function of the container 12. Apart from these facets 15, both the top portion 14 and the bottom portion 16 of the container 12 have a substantially square or rectangular plan configuration.

In the practice of the invention, it is preferable that the container be provided with venting to allow plants positioned in the closed container to have access to fresh air. The simplest manner of providing the desired venting is the well-known expedient of providing openings in the walls of the container. In the container 12 of FIGS. 2-5, these openings (not shown) may be provided in the top portion 14 and/or the bottom portion 16. FIG. 6 illustrates another way in which the venting may be provided. The container 12′ shown in FIG. 6 has a top portion 14′ and a bottom portion 16′. These two portions 14′, 16′ meet along an interface 18′. Unlike the interface 18 of the container 12 shown in FIGS. 2-5, the interface 18′ of this second embodiment of the container 12′ is interrupted by a series of gaps 30 between the top portion 14′ and the bottom portion 16′ when the container 12′ is closed. Venting is provided through these gaps 30. The gaps 30 between the container portions 14′, 16′ are maintained by a plurality of pairs of spacers 28. A spacer 28 projects downwardly from the top portion 14′, and a corresponding spacer 28 extends upwardly from the bottom portion 16′ to engage the spacer 28 carried by the top portion 14′.

An optional feature of the second embodiment of the invention is a latch to releasably secure the container in its closed position. The inclusion of this feature is preferred when a container is used that may have a tendency to pop open at undesired times. FIG. 6 illustrates one possible embodiment of a latch for use in the container. Referring to FIG. 6, the container 12′ has a hinge 22′ that extends along a side portion of the interface 18′. The latch mechanism extends along the interface 18′ opposite the hinge 22′. The latch includes a projection 24 that projects downwardly from the end of the top portion 14′. A corresponding slot 26 is formed in the bottom portion 16′ and is positioned to receive the projection 24, as shown in FIG. 6. The projection 24 has a friction fit in the slot 26 so that a positive force is required to disengage the projection 24 from the slot 26 and thereby disengage the latch to permit the container 12′ to be moved into an open position.

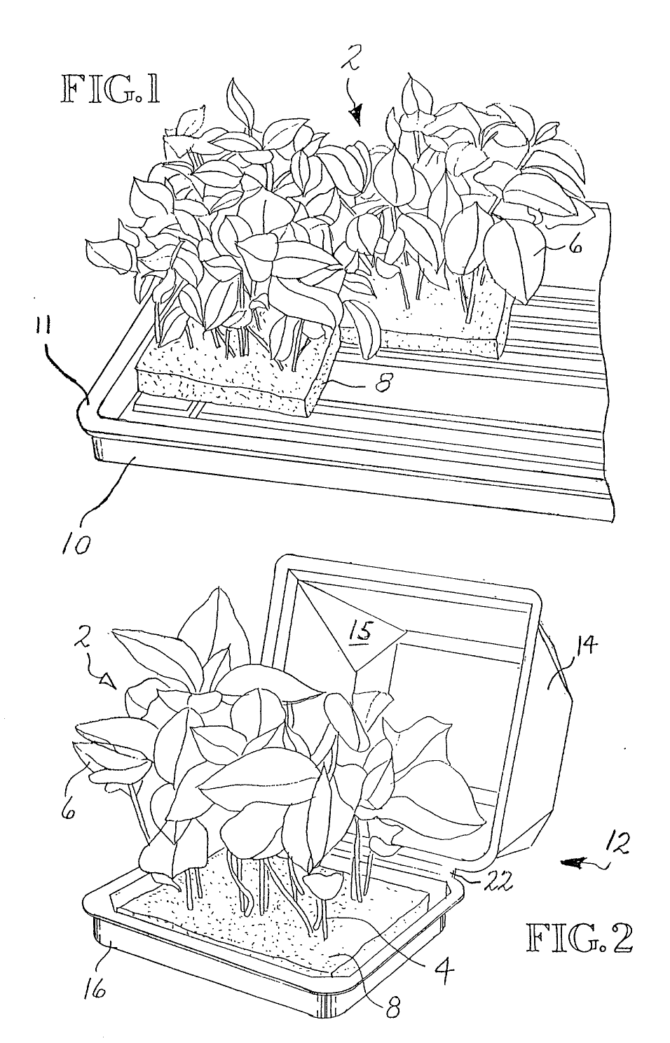

The method of the invention includes growing plants on a growing medium to a seedling stage. As defined above, the seedling stage is one at which both the stems and leaves of the plants remain soft and edible. Referring to FIGS. 1-5, edible seedlings suitable for use in the practice of the invention are generically illustrated. These plants 2 include stems 4 and leaves 6 formed on the stems 4. The stems 4 extend upwardly from the growing medium 8. It is currently anticipated that the method of the invention will be used primarily for the packaging of culinary herbs. Examples of such herbs include basil, chives, dill, parsley, marjoram, mint, oregano, rosemary, sage, sorrel, tarragon, and thyme. The method may also be used for the packaging of other edible plants that have a corresponding seedling stage. Examples of such plants are salad greens and spinach.

In the preferred embodiments of the invention, the plants are grown in a soilless growing medium. Soil could also be used as the growing medium, but soilless mediums are preferred because they generally are more free of undesired contamination. At present, it is anticipated that a sponge-pad type growing medium will be used. An example is a rooting sponge pad made from a mixture of peat moss, bark, and polyurethane foam that was developed by NASA and is currently commercially available. The sponge pad contains the media particles to prevent bits of media from being scattered throughout the container and contaminating the plants. Another example of a suitable medium is a rockwool product that has been used extensively in greenhouse vegetable farming and aquatic plant production since 1970.

The plants are started from seed or from cuttings of young new shoot growth. When the plants are started from seed, the growing period to the seedling stage is typically about four weeks or longer. While the young plants are growing, they are protected from extreme or adverse environmental conditions, such as extreme temperatures and changes in light, in order to ensure optimal growth without tough fibrous stems. The plants are provided with fertilization and moisture as needed. The needs of the plants vary according to the species of plant, as is known in the art.

In the second embodiment, before or after, but preferably after, the plants reach the seedling stage, the medium 8 is placed in the bottom portion 16 of a container 12. The growing procedure prior to placement of the plants in the container 12 is illustrated in FIG. 1, in which plants 2 are shown growing on medium 8 in a tray 10. When the medium 8 has been placed in the bottom portion 16, the container 12 is closed. The closed position of the container 12 is illustrated in FIGS. 3 and 4. When the container is provided with a latch, the closing of the container includes engaging the latch. The closed containers 12 are then ready for distribution for sale to consumers. As used herein, including in the appended claims, the term “distribution for sale to consumers” and the like refer to the initial distribution by the producer. Typically, the containers 12 are sent by the producer to a distribution center from which they are distributed to retailers, restaurants or other purchasers. The distribution of the containers 12 is carried out while the plants are still in the seedling stage and have a desired shelf life.

An important feature of the second embodiment of the invention is the use of a container 12 that has top and bottom portions 14, 16 with height dimensions HT, HP that meet specific criteria. The bottom portion 16 has a height dimension HB that is relatively shallow so that a top surface of the growing medium 8 placed in the bottom portion 16 is closely adjacent to the interface 18. This relative positioning is perhaps best seen in FIG. 4. The top portion 14 has a height dimension HT that is sufficient so that, when the container 12 is in its closed position and the medium 8 is in the bottom portion 16 with the plants in the seedling stage extending upwardly therefrom, the plants 2 are freely received in and protected by the top portion 14. This relationship is illustrated by FIGS. 3 and 4. The term “freely received” is intended to be understood as meaning received into the top portion 14 without undue crowding and without the tops of the plants 2 being damaged by the top wall of the container 12.

With the plants carried by and protected by the container 12, they may be safely shipped to distribution centers, retail establishments, restaurants, and/or individual consumers. As described above, the containers may be readily displayed to consumers so that consumers can locate them without difficulty. In addition, the manner in which the plants 2 are grown and distributed helps maximize their shelf life so that the consumer is much more likely to obtain a fresh product. For example, the shelf life of the plants 2 from the time of the original distribution from the producer is typically about ten days to fourteen days. The shipping, display, and storage of the plants with the roots still attached help maintain their shelf life. In contrast, cut fresh herbs have a shelf life of only about three to five days.

FIG. 5 illustrates one of the ways in which the method of the invention helps maximize the ease of use of the product by the consumer. FIG. 5 shows the container 12 in an open position in which the top portion 14 is moved upwardly and rearwardly away from the bottom portion 16 to provide easy access to the contents of the container 12. The contents include the growing medium 8 positioned in the bottom portion 16 with the stems 4 of the plants 2 in the seedling stage extending upwardly from the medium 8. The plants 2 are easily accessible to a consumer to allow the stems 4 to be snipped off near the growing medium 8. They may be snipped by hand or with scissors S or some other suitable tool. This quickly allows the consumer to remove the desired quantity of plants 2 for immediate use. The removal is accomplished with minimal waste since all of the plant parts that are removed, including both leaves 6 and stems 4, are edible. When the desired number of plants 2 have been removed, the container 12 is easily closed and stored so that the remaining plants 2 can be consumed at a later time. This whole procedure is accomplished without any need for removing the growing medium 8 or the plants 2 that are to be saved from the container 12.

As described above, in the first embodiment of the invention, the plants in the seedling stage are distributed in a tray rather than in a container. This embodiment of the invention comprises providing a tray, such as the tray 10 shown in FIG. 1, that includes a bottom surface and an upper edge surface 11. The tray has a predetermined height dimension HB extending from the bottom surface to the upper edge surface 11. As in the second embodiment of the invention, the plants are grown on a growing medium 8 to the seedling stage. The medium 8 is placed in the tray before or after the growing of the plants to the seedling stage. In some circumstances, it is most efficient to place the medium 8 in the tray 10 prior to the growing of the plants so that the plants are grown and distributed in the same tray 10 and require a minimum amount of handling. When the plants have reached the seedling stage and are still in the seedling stage, the tray 10, with the medium 8 placed in the tray 10 and the plants growing on the medium 8, is distributed for sale to a consumer.

In most cases, the tray 10 has no cover although a cover could be provided. If a cover is provided, the practice of the first embodiment is much like that of the second embodiment except that the tray (container), and preferably the pad of growing medium, are oversized. Since the tray 10 ordinarily has no cover, a plurality of coverless trays 10 are preferably shipped in a cardboard box that has shelves to provide support for the trays 10. The box then protects the medium and the plants during shipping. The boxes may be sent to a distribution plant from which they would most commonly be distributed to restaurants or institutions that use large quantities of the plants. The boxes could also be distributed directly by the producer to the restaurants or institutions.

As is the case in the second embodiment which uses the container 12, the plants 2 in the first embodiment have a maximized shelf life so that the customer is more likely to obtain a fresh product. In addition, like the bottom portion 16 of the container 12, the height dimension HB of the tray 10 is such that a top surface of the growing medium 8 is closely adjacent to the upper edge surface 11 when the medium 8 is placed in the tray 10. This enables the customer to gain access to the plants by the simple snipping procedure illustrated in FIG. 5 and discussed above in connection with embodiments of the invention that use a container.

Although the preferred embodiments of the invention have been illustrated and described herein, it is intended to be understood by those skilled in the art that various modifications and omissions in form and detail may be made without departing from the spirit and scope of the invention as defined by the following claims.

What is claimed is:

1. A method of packaging edible seedlings for distribution to and use by consumers, said method comprising:
providing a tray including a bottom surface and an upper edge surface and having a predetermined height dimension extending from said bottom surface to said upper edge surface;
growing plants on a growing medium to a seedling stage;
placing said medium in said tray; and
distributing said tray, with said medium placed in said tray and said plants growing on said medium, for sale to a consumer while said plants are still in the seedling stage;
said height dimension being such that a top surface of said growing medium is closely adjacent to said upper edge surface when said medium is placed in said tray.

2. The method of claim 1, wherein said plants are culinary herbs.

3. The method of claim 1, wherein growing said plants to said seedling stage comprises growing said plants from seed for at least about four weeks.

4. A method of packaging edible seedlings for distribution to and use by consumers, said method comprising:
providing a container including a top portion and a bottom portion, said container having a closed position in which said top portion and said bottom portion meet at an interface;
growing plants on a growing medium to a seedling stage;
placing said medium in said bottom portion of said container;
closing said container, with said medium in said bottom portion, into said closed position; and
distributing the closed container for sale to a consumer while said plants are still in the seedling stage;
said bottom portion having a height dimension such that a top surface of said growing medium is closely adjacent to said interface when said medium is placed in said bottom portion, and said top portion having a height dimension such that, when said container is in said closed position and said medium is in said bottom portion with said plants in the seedling stage extending upwardly therefrom, said plants are freely received in and protected by said top portion.

5. The method of claim 4, wherein said top portion and said bottom portion are hingedly connected to each other along a side portion of said interface.

6. The method of claim 5, wherein said container includes a latch opposite said side portion of said interface to releasably secure said container in said closed position, and closing said container includes engaging said latch.

7. The method of claim 4, wherein said container includes a latch to releasably secure said container in said closed position, and closing said container includes engaging said latch.

8. The method of claim 4, comprising providing said container with venting to allow said plants to have access to fresh air when said plants are in said container and said container is in said closed position.

9. The method of claim 8, wherein providing said container with venting comprises leaving at least one gap between said top portion and said bottom portion when said container is in said closed position.

10. The method of claim 4, wherein said container has an open position in which, when said medium is in said bottom portion with said plants in the seedling stage extending upwardly from said medium, said plants are easily accessible to a user to allow stem portions of said plants to be snipped.

11. The method of claim 5, wherein said container has an open position in which, when said medium is in said bottom portion with said plants in the seedling stage extending upwardly from said medium, said plants are easily accessible to a user to allow stem portions of said plants to be snipped.

12. The method of claim 4, wherein said plants are culinary herbs.

13. The method of claim 4, comprising providing a plurality of said containers, and providing said top portion and said bottom portion of each container with complementary portions to facilitate stacking of the containers and inhibit accidental tipping of a stack of the containers.

14. The method of claim 4, wherein said medium is placed in said bottom portion after said plants have been grown to the seedling stage.

15. The method of claim 4, wherein growing said plants to said seedling stage comprises growing said plants from seed for at least about four weeks.
